(19) United States
(12) Patent Application Publication
(10) Pub. No.: US 2010/0010961 A1
(43) Pub. Date: Jan. 14, 2010

(54) DISTRIBUTED DIRECTORIES

(75) Inventors: Yogesh V. Golwalkar, Maharashtra (IN); Magesh Rajamani, Maharashtra (IN)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/172,267

(22) Filed: Jul. 13, 2008

(51) Int. Cl. G06F 17/30

(52) U.S. Cl. 707/2

(57) ABSTRACT

Disclosed is a method for improving performance of distributed directory servers, which includes identifying directory servers configured to serve a partition index; monitoring the directory servers to identify whether a primary directory server has reached a maximum number of allowable entries in the partition index; and dynamically allocating a secondary directory server to the partition index on determining that the primary directory server has reached the maximum number of allowable entries in the partition index.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### FIELD OF THE INVENTION

This invention is related to distributed directories, and more particularly a system and method for operating distributed directories.

### SUMMARY OF THE INVENTION

Organizations rely on their IT infrastructure in order to conduct business. Organizations can store all their data on a central directory server. However, central directory servers can become cumbersome in the face of increasing storage demands. When a central directory server reaches its storage capacity or data transfer rate limitations, it can be decommissioned and replaced with a more adept model. However, this approach can result in high capital outlay and the inability to adequately cater to unexpected demands.

Organizations can overcome this problem by utilizing a distributed directory structure. FIG. 1 shows an example of a typical distributed directory system 100. In such a distributed directory system 100, there are a number of stand alone directory servers 110 also referred to as Primary Directory (PD) servers. Data is partitioned across the PD servers 110. In order for the PD servers 110 to appear to the end user to be a single large directory server or Virtual directory, a proxy server 170 is used. The proxy server 170 contains a hash table containing the PD servers 110. For example, when a directory request is received at the proxy server 170, the proxy server 170 performs a lookup to resolve the correct PD server 110. The request is then forwarded to the correct PD server 110. The complete process being transparent to the end user.

With the use of distributed directory servers, for example, it may occur that PD server A 120 reaches its storage limitation while the PD servers B 130 and PD servers C 150 are only half full. To overcome resource consumption inequality, organizations can power down. the system, attach an additional PD server D 160, redistribute the data evenly across all of the PD servers 110, reconfigure the proxy server 170 with the new addresses and then power up the entire system again. This process requires system downtime.

This disclosure is directed to a method and a system for improving the performance of distributed directory servers by identifying directory servers configured to serve a partition index. Monitoring the directory servers to identify whether a primary directory server has reached a maximum number of allowable entries in the partition index, and then dynamically allocating a secondary directory server to the partition index on determining that the primary directory server has reached the maximum number of allowable entries in the partition index.

In at least some embodiments, a proxy server can be configured to dynamically add the second directory server; and the proxy server can be configured to maintain at least one of a host or a port information of the secondary directory server.

In at least some embodiments, the method can further include storing new entries in the secondary directory server after allocation of the secondary directory server; and creating a separate distinguished name for the entries.

Additional features and advantages are realized through the techniques of the present invention. Other embodiments and aspects of the invention are described in detail herein and are considered a part of the claimed invention. For a better understanding of the invention with advantages and features, refer to the description and to the drawings.

With at least some embodiments of this disclosure, a partition can be added dynamically without the need for any downtime, since a single directory can not efficiently handle more than “n” number of entries, where “n” varies for different deployments and/or vendors.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example of a distributed directory system;

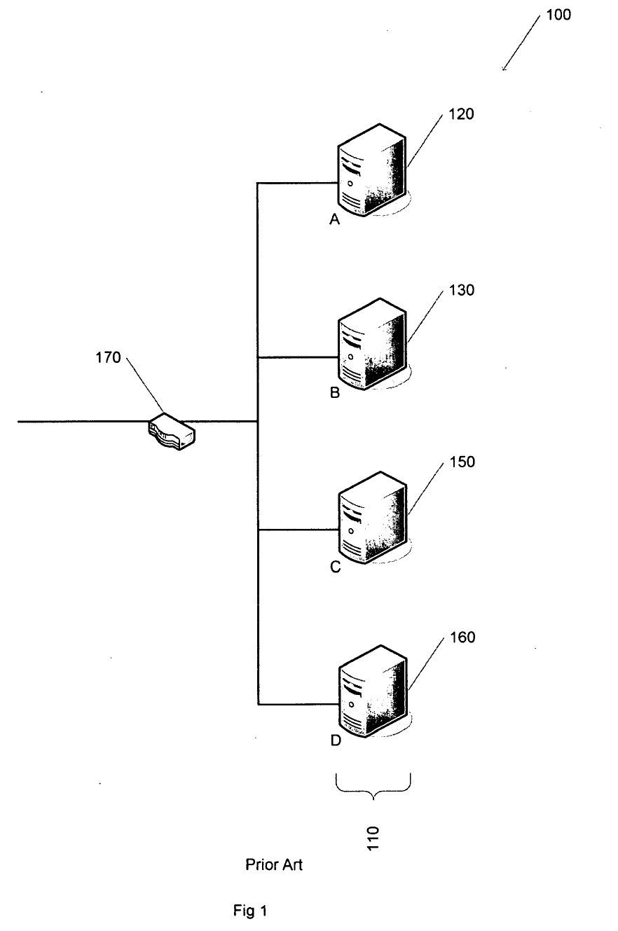

FIG. 2 shows an example of a Directory Information Tree (DIT);

FIG. 3 shows the steps of an example method for adding an LDAP (Lightweight Directory Access Protocol) entry in a proxy server; and

FIG. 4 shows the steps of performing an example directory operation.

The detailed description explains exemplary embodiments of the invention, together with advantages and features, by way of example with reference to the drawings.

### DETAILED DESCRIPTION OF THE INVENTION

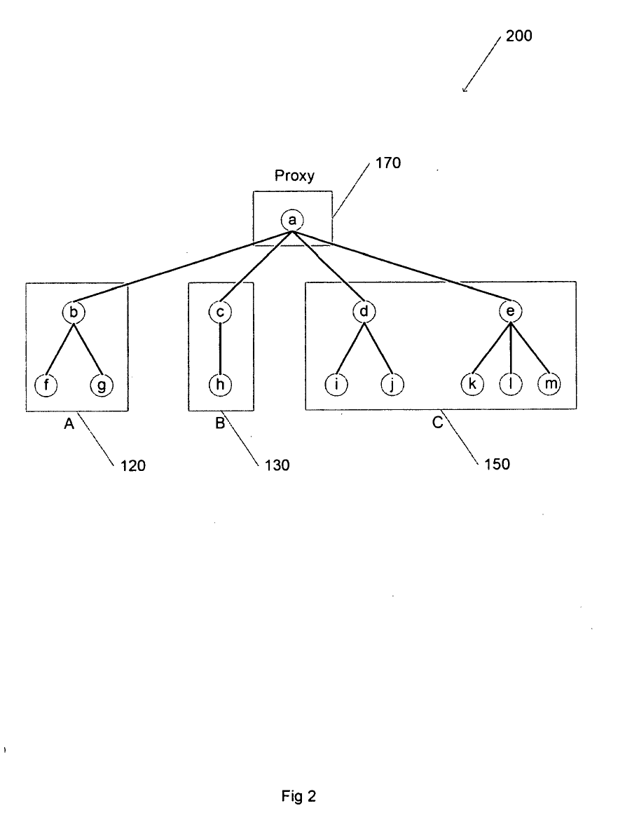

FIG. 2 shows an example of a Directory Information Tree (DIT) 200 according to system 100. Each server A 120, B 130 and C 150 contains a directory. Each directory consists of a number of directory entries denoted in lowercase. Thus PD server A contains entries a, b, f and g, PD server B contains entries a, c and h and PD server C contains entries a, d, e, i, j, k, l and m.

Each entry of the DIT 200 can be represented by a distinguished name (DN). For example, entry f has a DN of fba. In another example, entry l has a DN of lea. Each entry can also be represented by a relative DN (RDN) which is the address of the entry relative to its patent entry. For example the relative address of entry f to entry b is f. In another example, the relative address of entry l to entry e is l.

The proxy server 170 maintains a hash table and hash algorithm to resolve LDAP directory operations. In this example server A 120 has been assigned a first hash index, server B 130 has been assigned a second hash index, and server C has been assigned a third hash index. When the proxy server receives a directory operation, it performs a lookup on the RDN just below the split DN. In this instance, the split DN is a. Therefore, for example, when the proxy server 170 receives a directory operation for entry mea, it will perform a lookup for the RDN (e) just below the split DN (a). In this way, the proxy server forwards the directory operation to server C 150.

When a PD server is about to reach its storage limitations and additional resources are required, an Extended Directory (ED) server may be attached to system 100. For example, if PD server C 150 were to reach its storage limitation, an ED server 160 may be added to system 100. Thus all new data destined for PD server 150 will now be stored on the associated ED server 160. The ED server 160 resides within the same partition index as its associated PD server 150. And number of ED servers may be associated with a PD server in this manner. ED servers may also be associated with other ED servers.

Once an ED server D 160 has been associated with a PD server 150, new data entries will be forwarded to the ED server 160. In order to resolve the subsequent addressing issue, the configuration is altered to reflect that an ED server 160 has been associated with the PD server 150. Thus, when a directory operation is received by the proxy 170 requesting that data be stored on a PD server C 150, the proxy 170 will firstly check to see if there is an associated ED server D 160 by checking the configuration. If the configuration indicates that there is no associated ED server D 160, the operation is performed on the PD server C 150, Alternatively, if the configuration indicates that there is an associated ED server D 160, a Tag Entry (TG_ENT) in created on the PD server C 150, an associated Dummy Tag Entry (TG_ENT) is created on ED server D 160 and the operation is forwarded to the ED server D 160. Thus, in subsequent operations, the existence of a TG_ENT in the PD server C 150 and the ED server 160 D indicates that the operation should be forwarded to the ED server D 160. As the ED server D 160 is assigned to the same partition index as its associated PD server C 150, the hash table of the proxy server 170 does not need to be updated, thereby eliminating the requirement for system downtime to recreate the hash table.

ED Server Add Operation

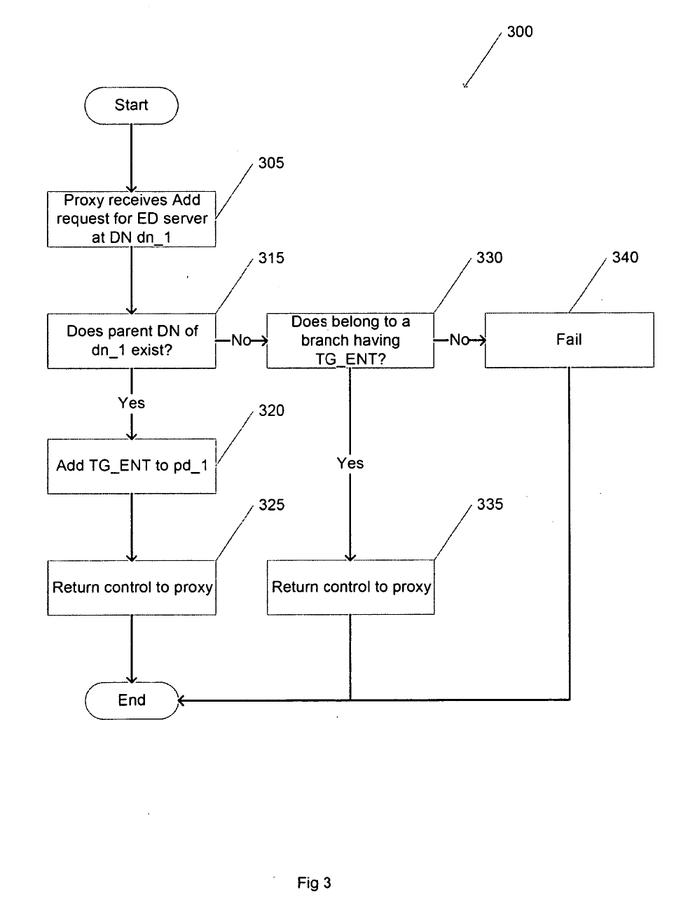

FIG. 3 shows the steps of an example method 300 for adding an LDAP entry to the proxy server 170. The method begins at step 305 where the proxy 170 receives a request from a user to add an LDAP entry having DN dn_{—}1. The proxy server 170 will then send the request to the appropriate PD server 150 containing a control comprising information about the ED server D 160 and where the entry will actually be stored. At step 315 the PD server 150 will determine if the parent DN of dn_{—}1 exists on the server. If the parent DN of dn_{—}1 does exist on the server, at step 320 a Tag Entry (TG_ENT) is added to the PD server 150. TG_ENT contains dn_1 and also the host or port information of the ED server 160. At step 325, the control is updated and sent back to the proxy server 170. This information includes the following:
1. The host or port information of the ED server as stored in TG_ENT.
2. A UUID (universally unique identifier) of TG_ENT.
3. The DN of TG_ENT (in this case it is dn_{—}1)
4. The effective ACL (Access control list) for TG_ENT

Once the proxy server 170 receives the control it creates a dummy tag entry in the designated ED. Thereafter the DN for the add request is translated to a DN on the ED server and then sent to the ED server.

If, however, at step 315 it is determined that parent DN of dn_{—}1 does not exist, the PD server 150 determines if dn_{—}1 belongs to a branch of the DIT which contains a TG_ENT at step 330. If at step 330 the PD server 150 determines that dn_{—}1 does belong to a branch having a TG_ENT, at step 335, the control is updated with the information from TG_ENT and sent back to the proxy server 170. This information includes the following:
1. The host or port information from TG_ENT.
2. A UUID of TG_ENT.
3. The DN of TG_ENT
4. The effective ACL for TG_ENT
   This information is then sent to the ED server.

If at step 330 the PD server 150 determines that dn_{—}1 does not belong to a branch having a TG_ENT, in other words that an entry is being added without a parent, at step 340 the appropriate LDAP error code is returned to the proxy 170.

ED Server Proxy Cache

In order to avoid having to query the TG_ENT of the PD server 150 for each directory operation, a cache is maintained at the proxy server 170. In this manner, when the proxy 170 receives a directory operation, the ED server cache is first queried. If a corresponding entry is found, the operation is sent directly to the appropriate ED server 160, without having to query the PD server 150 to see if a TG_ENT exists. This saves at least one network based operation per operation.

Performing a Directory Operation

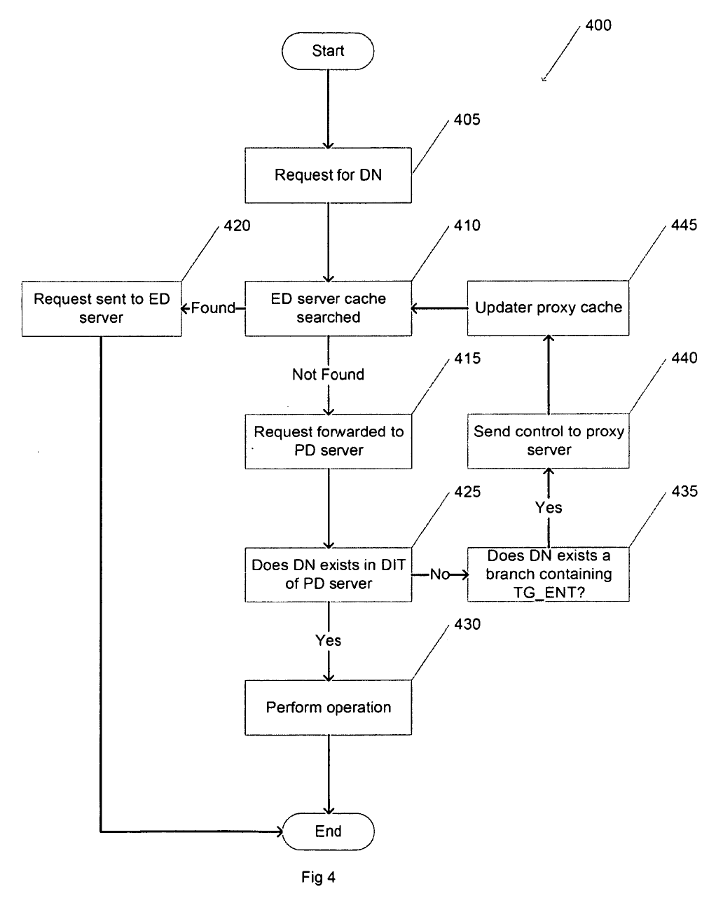

Method 400 in FIG. 4 shows the steps of performing an example directory operation. The method 400 starts at step 405 where the proxy 170 receives an operation for DN dn_{—}1. At step 410, the ED server cache is searched. If the entry is found in the ED server cache, the operation for dn_{—}1 is forwarded directly to the ED server D 160 in step 420. If dn_{—}1 is not found in the cache, in step 415 the request is forwarded to the appropriate PD server 150. The PD server at step 425 will search for the requested DN in its DIT. If the DN is found, the operation is performed at step 430. If the requested DN is not found, at step 435 the PD server 150 determines if the DN belongs to a branch of the DIT having a TG_ENT. If the DN does belong to a branch of the DIT having a TG_ENT, a control similar to the control described in method 300 containing information about the host or port information of the ED server 160 is sent back to the proxy server 170 at step 440. At step 445 the proxy server 170 receives the control and updates the ED server cache in the Proxy 170. Once the ED server cache has been updated, the request then is restarted at step 410.

Delete Operation

If a delete operation is received by the proxy server 170, the steps of method 400 are performed in addition to the step of the PD server deleting its TG_ENT if the DN of the TG_ENT matches the DN of the operation.

Searching

When a proxy 170 receives a search operation for a PD server having an associated ED server 160, it does not know if the information resides in the PD server 150 or its associated ED server 160.

Thus for search operations, the proxy 170 will send the search operation to the PD server 150 regardless of whether a corresponding entry is found in the ED server cache. The PD server 150 will perform the search operation and send the result back to the proxy 170. However, if the PD encounters a TG_ENT in a result, it will send a control similar to the control described in method 300 containing information about the host or port information of the ED server back to the proxy server 170. For search operations where the proxy server 170 receives a control, it will first search the corresponding ED server 160 identified by the control. Once the PD server 150 and ED server 160 have been searched, the result will then be returned

Base scope searches are an exception in that if an entry is found in the ED server cache, the ED server is searched only.

While exemplary embodiments of the invention have been described, it will be understood that those skilled in the art, both now and in the future, may make various improvements and enhancements which fall within the scope of the claims which follow. These claims should be construed to maintain the proper protection for the invention first described.

1. A method for improving performance of a distributed directory structure having a number of distributed directory servers, the method comprising:
identifying directory servers configured to serve a partition index;
monitoring the directory servers to identify whether a primary directory server has reached a maximum number of allowable entries in the partition index;
dynamically allocating a secondary directory server to the partition index on determining that the primary directory server has reached the maximum number of allowable entries in the partition index;
storing all new entries in the secondary directory server after allocation of the secondary directory server; and
creating a separate distinguished name for the entries;
wherein a proxy server is configured to dynamically add the second directory server; and
wherein the proxy server is configured to maintain at least one of a host or a port information of the secondary directory server.
